(19) United States
(12) Patent Application Publication
(10) Pub. No.: US 2007/0200505 A1
(43) Pub. Date: Aug. 30, 2007

(54) Projection light source and methods of manufacture

(76) Inventors: Ju Gao, Champaign, IL (US); Wayne Hellman, Aurora, OH (US); Abbas Lamouri, Aurora, OH (US); Steve Stockdale, Aurora, OH (US); Juris Sulcs, Chagrin Falls, OH (US)

Correspondence Address: DUANE MORRIS LLP, Suite 700, 1667 K Street, N.W., Washington, DC, 20006, US

(21) Appl. No.: 11/645,725

(22) Filed: Dec. 27, 2006

Related U.S. Application Data
(60) Provisional application No. 60/753,425, filed on Dec. 27, 2005.

(51) Int. Cl. H01J 17/20; H01J 61/12

(52) U.S. Cl. 313/637; 313/114; 313/638

(57) ABSTRACT

A projection light source may include a housing and an arc tube supported by the housing. The arc tube may include an arc tube body having a bulbous chamber intermediate sealed end portions, a pair of electrodes, a fill gas contained within the chamber, a fill material contained within the chamber, and a generally ellipsoidal reflector supported by the housing. The arc tube and the reflector may be positioned so that a focus of the generally ellipsoidal reflector lies on an axis extending between the interior tips of the electrodes of the arc tube.

The disclosure claims the filing-date benefit of Provisional Application No. 60/753,425, filed Dec. 27, 2005, the specification of which is incorporated herein in its entirety.

### CROSS REFERENCE TO RELATED APPLICATIONS

The present application is related to U.S. Pat. No. 6,546,752 entitled “METHOD OF MAKING OPTICAL COUPLING DEVICE” issued Apr. 15, 2003; U.S. Pat. No. 6,304,693 entitled “EFFICIENT ARRANGEMENT FOR COUPLING LIGHT BETWEEN LIGHT SOURCE AND LIGHT GUIDE” issued Oct. 16, 2001; U.S. Pat. No. 6,612,892 entitled “HIGH INTENSITY DISCHARGE LAMPS, ARC TUBES, AND METHODS OF MANUFACTURE,” issued Sep. 2, 2003; U.S. Pat. No. 6,517,404 entitled “HIGH INTENSITY DISCHARGE LAMPS, ARC TUBES, AND METHODS OF MANUFACTURE,” issued Feb. 11, 2003; and U.S. patent application Ser. No. 10/457,442, entitled “HIGH INTENSITY DISCHARGE LAMPS, ARC TUBES, AND METHODS OF MANUFACTURE,” filed Jun. 10, 2003 (published as U.S. Pat. Pub. No. 2004-0014391), the disclosures of which are hereby incorporated by reference.

### BACKGROUND

Projection systems for televisions, home entertainment and business presentations include technologies such as Digital Light Processing, or DLP™, variations of Liquid Crystal Displays, (LCD), and Liquid Crystal on Silicon (LCoS). Regardless of the technology of the projection system, these devices face similar trends in the marketplace of increased demand for smaller, lighter and cheaper systems.

A general overview of DLP™ technology will highlight some of the demands on projection light sources. DLP™ technology uses a microchip with an array of hinge mounted digital micromirrors, each of which selectively project light into the viewing image depending on the position of the micromirror. Such a micromirror system is commonly referred to as a Digital Micromirror Device, or DMD.

A digital code directs each mirror to tilt on or off several thousand times per second. The average time that light is reflected onto a pixel determines the shade of the pixel, rendering over a thousand different shades. To project color, the projection light source generates white light that passes through a color wheel as it travels to the surface of the DMD chip. The color wheel consists of red, green and blue color (“RGB”) filters, from which a single-chip DMD system can create at least 16.7 million colors from a single light source. In many prior art systems, the RGB color wheel also includes white sectors to enhance the brightness of the image. In three chip versions, DMD projection systems produce over 35 trillion colors.

This ability to produce color and the demand for smaller, lighter and cheaper systems places a significant demand on the projection light source. High quantities of light need to be generated at a correlated color temperature (“CCT”) of about 6500 K. Conventional metal halide lamps have been unsuitable either for having a CCT that is too low, or by producing insufficient amounts of light. The prior art has turned to high pressure mercury lamps to achieve the desired color rendering and lumens suitable for projection lighting.

As a result, digital projection lighting systems typically use high power, high lumens mercury discharge light sources. The conventional projection light has a power rating of 100 W or higher, mainly due to the generalization that more lumens result from higher wattage in lamps. From this conventional wisdom, Ultra-High Pressure (“UHP”) lamps have evolved having arc tube pressures greater than 150 atm. Such ultra high pressures are generated by mercury fills of at least 150 mg/cc. Generally, the higher the vapor pressure of the mercury, the more suitable the discharge is for projection purposes. The lamp pressure is limited, in part by the strength of the lamp element and its seals.

The possibility of rupture or leakage presents significant drawbacks to the safety and product life of UHP lamps. In particular, the high pressures required by prior art devices present significant safety issues. Reinforcement of the lamp element and seals results in devices less suitable for small size or portability, and these devices still fail despite reinforcement. For instance, the failure mode of UHP lamps tends to be catastrophic. Failing UHP lamps tend to explode, releasing shards of glass and metal at high velocities and in many different directions. A typical UHP burner contains approximately 2.5 Joules of energy which is released in such an explosion. Sometimes, pieces of glass or metal can pierce or pass through the surrounding enclosure. In view of the catastrophic nature of the failure of such lamps, the thick electrode which operates as the anode in such lamps is typically referred to as the “bullet” because it often pierces the structure of the projector when the lamp ruptures. Alternatively, even if the explosion might be contained within the enclosure, the sound of the explosion is disconcerting to users.

For example, Takahashi et al. (U.S. Pat. Pub. No. 2004-0150343) describes a UHP lamp suitable for a projection light source. Takahashi et al. is directed to a high pressure discharge lamp element capable of withstanding pressures of 400 atm or more. The arc tube is constructed via a compound structure of quartz and Vycor glass and is thermally treated during manufacture to increase compressive stress in the end lamp. The disclosure claims loading the lamp element with up to 300 mg/cm3 of mercury. Such high pressures are undesirable in a commercial product.

The objective in projection lighting systems is to project light in sufficient amounts at the proper colors to obtain a viewing image having a desirable brightness and color quality. Several design limitations must be overcome. For example, in a typical projection system the light is filtered by a RGB or RGBW filter. Thus important design factors include projecting as much light as possible onto the RGB (or RGBW) filter, and obtaining as much filtered light as possible.

An important characteristic considered in selecting a light source for a projection lighting system is the lumens per etendue characteristic of the light source. Several physical characteristics of the lamp such as arc gap and fill pressure affect the lumen per etendue characteristic of the lamp. In order to meet the lumens per etendue demands, UHP lamps must operate at high fill pressures in order to constrict the arc. As discussed above, such high fill pressures can be detrimental at lamp failure.

Another important characteristic of a single panel the system (e.g., a DLP system using a color wheel for color separation) is the color separation efficiency of the system, i.e., the efficiency of the system in separating the light projected by the source into red, green and blue. The color wheels used in single panel DLP systems and similar display light engines generally employ either an RGB (red-green-blue), RGBW (red-green-blue-white), of a RGBYW (red-green-blue-yellow-white) color wheel to sequentially filter the light received from the light source. Ideally, an RGB color wheel includes only red, green, and blue sectors of equal proportion (approximately 120 degrees).

For purposes of this disclosure, the term “color separation efficiency” means the sum (in lumens) of each of the filtered red, filtered green, and filtered blue light passing through a color wheel weighted by the respective percentage of the total filter represented by each color sector divided by the total incident light (in lumens) on the filter. For example, in a color wheel where each of the red and green filters represent 35% of the total filter, and the blue filter represents 30% of the total filter, the lumens of filtered red and filtered green are weighted by a factor of 0.35 and the lumens of filtered blue are weighted by a factor of 0.30. Prior art systems typically achieve color filter efficiencies of less than twenty-five percent. Ideal color filter efficiency is generally considered to be thirty-three percent.

Since conventional light sources such as UHP lamps are not spectrally matched to a particular color wheel in a DPL system, the color wheel must be customized to compensate for the various lumens and color performance of the various UHP lamps. For instance, UHP lamps are generally deficient in red while producing a greater amount of blue light. The color wheel in a DLP system must be changed to include a compensating larger proportion of red filter as compared to blue, thereby reducing the color separation efficiency of the system. Moreover, RGBW and RGBYW color wheels are often necessary to provide a white and/or yellow portion to boost screen lumens, further decreasing color separation efficiency. The blast of white and/or yellow light across the screen, although successful in creating the visual impression of a brighter screen image, adversely affects the image quality by desaturating the color. Some conventional systems employ approximately 100 degrees of white space in the color wheels to boost lumens at the cost of color quality.

Additionally, the market lacks a standardized projection light source. Lamp life is commonly less than the life of the projection system as a whole. System designers have little ability to compare the quality of available lamps due to the variation of parameters such as focal length, physical dimension, wattage etc. As a result, lamps are often custom-made to a specific projection light system, driving prices up and leaving consumers and manufacturers facing a myriad of lamps that may be compatible with only one or two particular models of projection light systems.

In the industry, there is a need to provide a less expensive, safer, lower power, lower luminance, standardized light source capable of generating light with sufficient efficiency and quality to meet the demands of projection lighting.

### SUMMARY

The present disclosure relates generally to projection lighting sources. In particular, the present disclosure relates to a low wattage metal halide lamp, a projection lighting source using such lamp, and methods.

Various disclosed embodiments are generally directed to a projection lighting source including a housing, an arc tube supported by the housing, and a generally ellipsoidal reflector. A projection lighting source is disclosed comprising a housing; an arc tube supported by said housing, said arc tube comprising: an arc tube body having a bulbous chamber intermediate sealed end portions; a pair of electrodes, each electrode extending from a sealed end portion into said chamber so that the distance between the interior tips of said electrodes is between about 1.0 mm and about 2.5 mm, each of said electrodes comprising a tungsten shank having a diameter between about 2.0 mm and about 4.0 mm; a fill gas contained within said chamber, said fill gas comprising one or more gases selected from the group consisting of argon, xenon, krypton and neon, said fill gas having a pressure less than about 5 atm at substantially room temperature; a fill material contained within said chamber, said fill material comprising one or more halides of one or more metals; and mercury contained within said chamber; and a generally ellipsoidal reflector supported by said housing, said arc tube and said reflector being positioned so that a focus of said generally ellipsoidal reflector lies on an axis extending between the interior tips of the electrodes of said arc tube.

A low wattage light source for a projection lighting system is disclosed comprising an arc tube containing a light emitting plasma including one or more metal halides and a reflector for directing light emitted from said plasma, said light source operating at no more than 50 watts and directing at least 800 lumens of light at an etendue of no more than 2.76 mm²sr.

A lamp for a projection lighting system using a color wheel for color separation is disclosed comprising a chamber containing a plasma including one or more metal halides, the composition of said metal halides being selected so that the color separation efficiency of the light emitted from said plasma is greater than 25%.

A projection lighting system is disclosed comprising a light source including an HID lamp coupled to a reflector for directing light emitted from said lamp to a color filter for sequentially filtering said light with a red, a green, and a blue filter, and optics for directing the filtered light to a viewing screen, wherein the lumens of filtered light is greater than about 5 per watt of operating power of said lamp; or wherein the ratio of lumens of filtered red, green and blue light to the lumens of light directed to said filter is greater than about 0.2; or wherein the lumens of light directed to the viewing screen is greater than about 2 per watt of operating power of said lamp.

A projection lighting system is disclosed comprising a light source including an HID lamp coupled to a reflector for directing light emitted from said lamp to a color wheel for sequentially filtering said light with red, green and blue filters, and optics for directing the filtered light to a viewing screen, wherein the color separation efficiency is greater than about 0.25 and wherein said red, green and blue filters form an RGB filter having substantially equal sectors of red, green and blue filters.

A projector is disclosed providing an image of at least 100 screen lumens, said projector having a light source comprising a metal halide lamp operating at a power of 50 watts or less.

A low wattage light source for a projection lighting system is disclosed comprising (a) an arc tube containing a light emitting plasma including mercury and one or more metal halides, and (b) a reflector for directing light emitted from said plasma, said light source operating at no more than 50 watts and directing at least 650 lumens of light at an etendue of no more than 2.76 mm²sr per gram of mercury contained in said arc tube.

A projector is disclosed providing an image of at least 100 screen lumens, said projector including a light source comprising a metal halide lamp operatively coupled to a ballast, said ballast providing a run up current to said lamp between 1.0 and 2.5 amps, a starting voltage greater than 5000 volts, and an operating voltage at greater than 1000 hertz.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the claims.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments, wherein:

FIG. 1 is an isometric view of a projection light source according to a disclosed embodiment.

FIG. 2 is the isometric view of the projection light source of FIG. 1 shown with the cover removed.

FIG. 3 is a side view of the projection light source of FIG. 1 with the cover removed.

FIG. 4 is the side view of the projection light source of FIG. 3 with the reflector removed.

FIG. 5 is a schematic represention-of a typical digital light processing projection system.

FIG. 6 is a schematic representation of a typical liquid crystal display projection system.

FIG. 7 is a graph showing the theoretical and simple model curve of lumens per etendue.

FIG. 8 is an isometric view of a projection light source according to another disclosed embodiment.

FIG. 9 is a side view of the projection light source of FIG. 8.

FIG. 10 is another isometric view of the projection light source of FIG. 8.

FIG. 11 is a side view of the projection light source of FIG. 8 with the cover removed.

FIGS. 12a and 12b are exemplary diagrams of reflector designs according to the disclosed embodiments.

FIG. 13 is a schematic representation of a liquid Crystal on Silicon system.

FIG. 14 is an xy chromaticity diagram illustrating the performance of a disclosed embodiment.

FIG. 15 is an exemplary illustration of an integrally formed housing and reflector.

FIGS. 16a and 16b are schematic representations of a halide pool in horizontally and vertically oriented arc tubes respectively.

FIG. 17 is a schematic representation of electrodes according to one aspect of the present invention.

FIG. 18 is a schematic representation of electrodes according to another aspect of the invention.

FIG. 19 is a schematic representation of a color wheel.

FIG. 20 is a schematic representation of a color wheel and associated power timing diagram.

FIG. 21 is a schematic representation of an electrode configuration within an arc tube.

FIG. 22 is a flow chart illustrating a disclosed embodiment for designing a light source.

### DETAILED DESCRIPTION

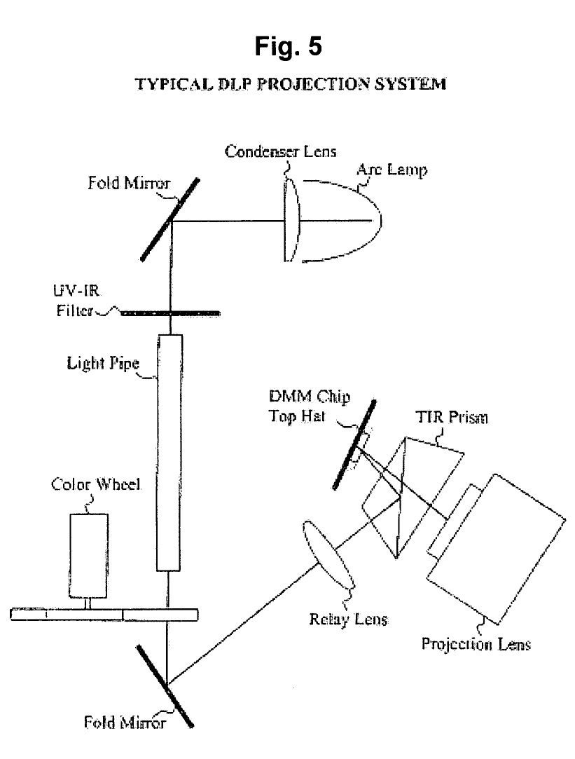

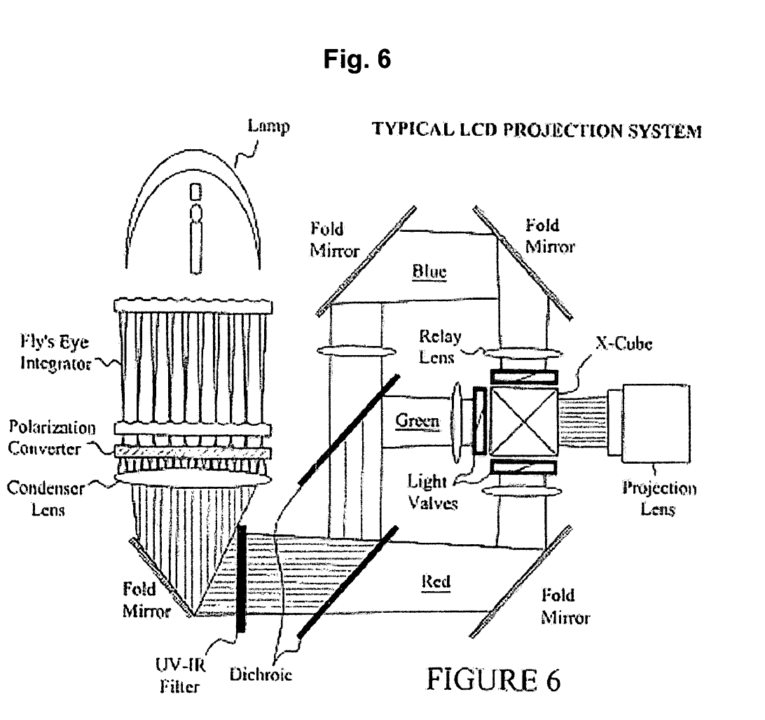

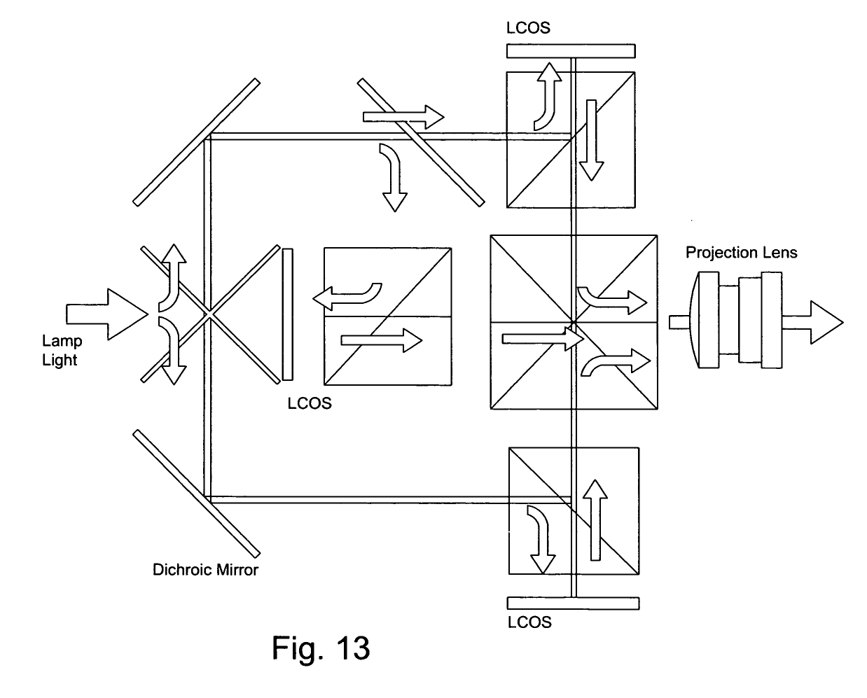

The present disclosure includes a metal halide lamp, a reflector, and a ballast. The present disclosure also includes a projection lighting source including a metal halide lamp coupled to a reflector, and a housing for carrying the lamp and reflector. The presently disclosed embodiments find utility in light sources for projection lighting systems, for example, a DLP system 10 depicted in FIG. 5, an LCD system 20 depicted in FIG. 6, or and LCoS system depicted in FIG. 13.

A projection lighting source according to a presently disclosed embodiment may comprise a housing carrying an arc tube having metal halide fill material, and a reflector coupled to the arc tube.

Low Wattage Considerations

Generally, the embodiments disclosed herein are directed to a low wattage light source for a projection lighting system. A low wattage light source for projection lighting systems is desirable for many reasons, including power consumption, heat generation and size.

In compact projection lighting systems, the heat effect is significant. For a typical metal halide lamp, over 30% of the input power is turned into heat in the form of heat radiation, conduction and convection. Thus, maintaining low power reduces the heat load on all components of the system. Power reduction also makes possible the removal of the conventional fan that generates noise and consumes additional power. Further, utilizing a low-wattage lamp minimizes space constraints and facilitates portability of the projection system.

Another consideration in developing a low-wattage projection lighting source is providing a light source having a lumens per etendue characteristic so that sufficient lumens can be collected on the screen despite the optical confinement within the system. Thus a discharge lamp having a small arc gap is necessary to meet the etendue limitations of a typical projection lighting system. However, arc tubes operating with a short arc gap results in a lower lamp voltage compared to arc tube with wider arc gaps. Consequently, the lamp current must be higher to achieve a given power level. The price of this high current is a higher load on the electrodes, thereby lowering lumens and shorter life time. Thus a low-wattage lamp is desirable to avoid the disadvantages of high current while realizing the advantage of a short arc gap.

Given the initial approach to reduce or minimize lamp power to below approximately 50 Watts, attention to achieving high screen lumens and color performance is then drawn to other factors including etendue efficiency, optical efficiency, and color wheel efficiency.

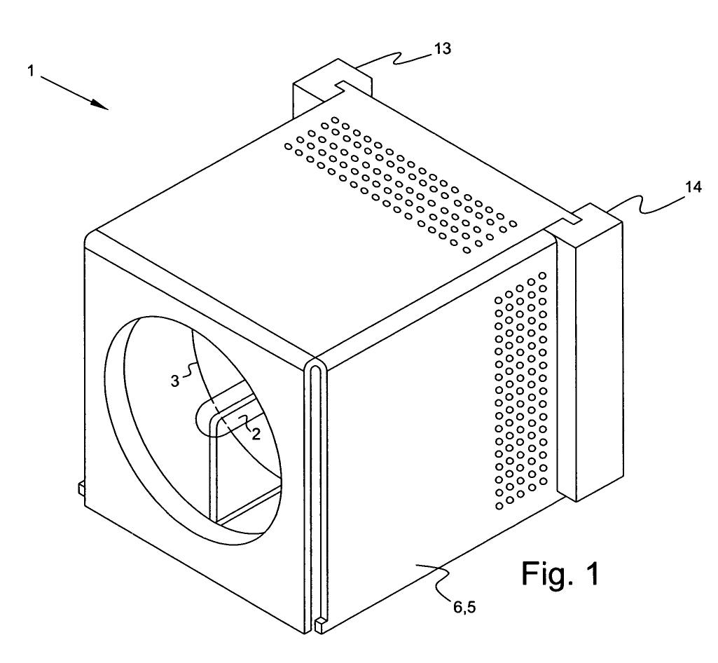

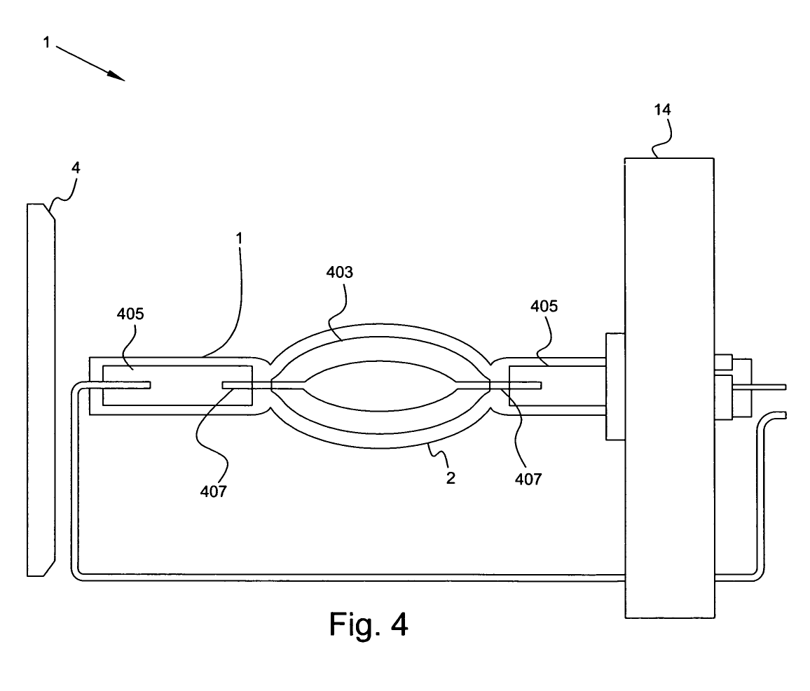

Referring to FIGS. 1-4 (and 8-11) there is illustrated a projection lighting source 1 (101) including an arc tube 2 (102), a reflector 3 (103) and a housing 5 (105).

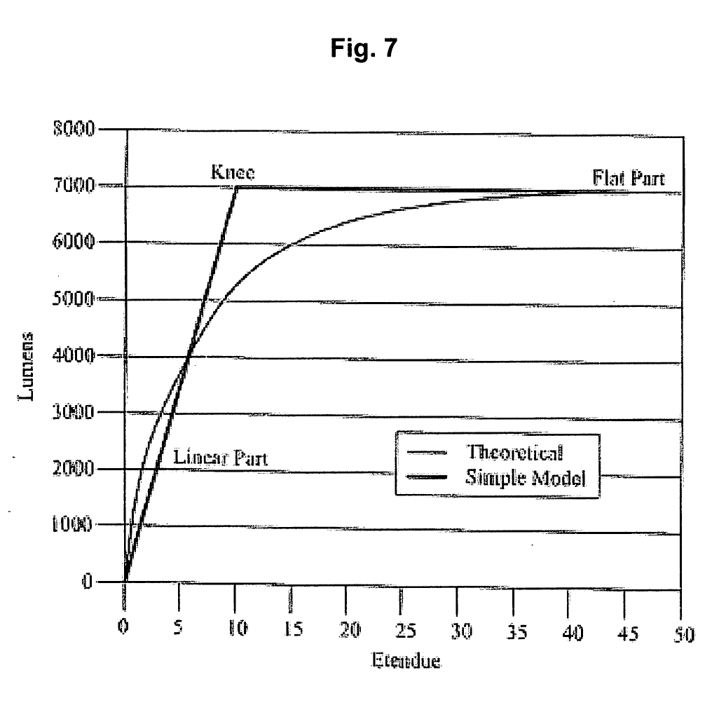

In determining the optimal arc tube fill material, optical interference filter, and light source coupling for the projection light source 1, consideration must be given to etendue through the light projection system, with emphasis at the point of the light source and at the point of color filtering. The lumens per etendue (mm².steradians) characteristic of the projection lighting source is determined by the physical geometry of the arc tube 2, the reflector 3 and the lens 4. FIG. 7 depicts an ideal and real curve of lumens as a function of etendue. For projection lighting systems, etendue at the light source is typically in the linear portion of the graph depicted in FIG. 7. In projection lighting sources, it is desirable to achieve high lumens for the given etendue constraint of the projection system.

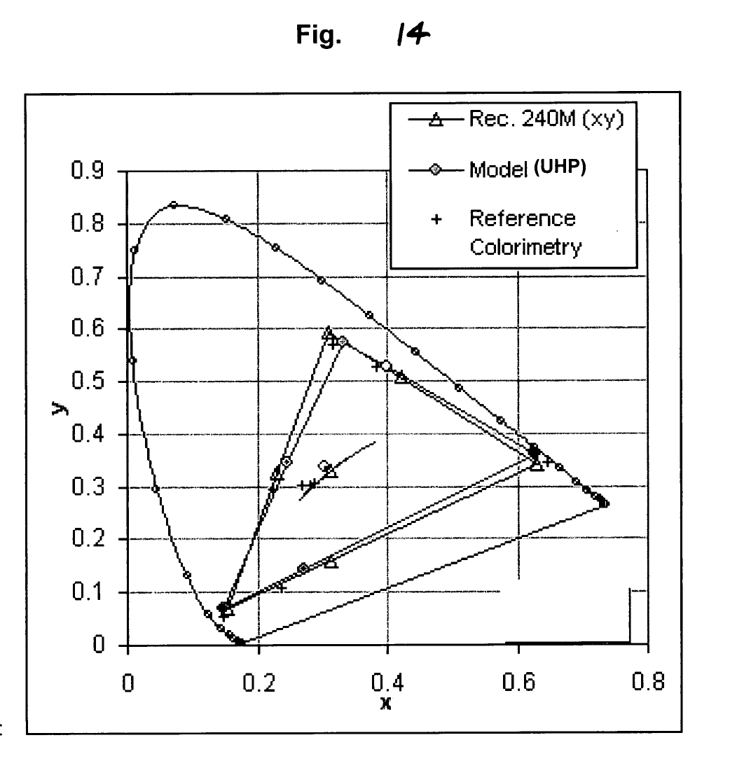

In one embodiment, a projection lighting source 1 is disclosed, including a housing 5, an arc tube 2 supported by the housing 5, and a generally ellipsoid reflector 3 supported by the housing 5 and coupled to the arc tube 2. The arc tube 2 includes an arc tube body having a bulbous chamber 403 intermediate sealed end portions 405, a pair of opposing electrodes 407, a fill gas (not shown) contained within the chamber 403, a fill material (not shown) contained in the chamber 30, and mercury (not shown) contained within the chamber 403. Each electrode 407 extends from a sealed end portion 405 into the chamber 403 so that the distance between the interior tips of the electrodes 407 (i.e., the arc gap) is between about 1.0 mm and about 2.5 mm. Each of said electrodes 407 includes a tungsten shank having a diameter between about 2.0 mm and about 4.0 mm. The fill gas includes one or more gases selected from the group consisting of argon, xenon, krypton and neon, and the fill gas typically has a pressure less than about 5 atm at substantially room temperature. The fill material includes one or more halides of one or more metals. The arc tube 2 and the reflector 3 are positioned relative to the other so that a focus of the ellipsoidal reflector 3 lies on an axis 221 extending between the interior tips of the electrodes 407 of the arc tube 2 as shown in FIG. 14.

Turning now to various other aspects and embodiments, the arc tube, reflector, and housing are described in further detail below.

### [I.] ARC TUBE

Embodiments presently disclosed reflect a solution-based approach to arc tube design. Both lumens and color issues are addressed by various design parameters. In one embodiment the arc tube is formed from quartz. In an alternative embodiment, the arc tube is formed from ceramic.

To achieve high screen lumens for a projection system according to disclosed embodiments, particular consideration is given to the size of the arc and color balance. A smaller arc enables more light to be focused into smaller apertures. This principle is related to etendue. With regard to color balance, it is desirable to balance the color among red, green and blue to achieve higher color wheel efficiency. As described above in the context of conventional devices, if one color (for example, blue or red or green) is deficient in the source, then a color wheel must be designed to enhance the color at the cost of other colors. As a result, screen lumens suffer.

### (A) SMALL ARC

The size of the arc may be reduced by reducing the arc gap in the arc tube and by varying the shape of the electrodes. The size of the arc may also be reduce by constricting the arc.

In various embodiments, the arc gap between electrodes is shortened to be less than 2.5 mm to gain higher etendue efficiency. Preferably, the arc gap is within the range of approximately 1.0 mm to approximately 2.5 mm. More preferably, the arc gap is within the range of approximately 1.6 mm to 1.9 mm. Even more preferably, the arc gap is approximately 1.7 mm. In experiments taking into consideration the impact of reduced arc gap on lumens and lamp life, a preferred range of arc gap is between 2.0 mm and 1.5 mm.

In selected embodiments, the electrodes in the arc tube are stick electrodes. In more preferred embodiments, the electrodes are tapered stick electrodes with a diameter of between 0.2 mm to 0.4 mm or preferably between 0.25 mm and 0.3 mm. Alternatively, the electrodes may be coiled. The electrodes may contain about 2% thorium. More preferably, the electrodes contain less than 2% thorium.

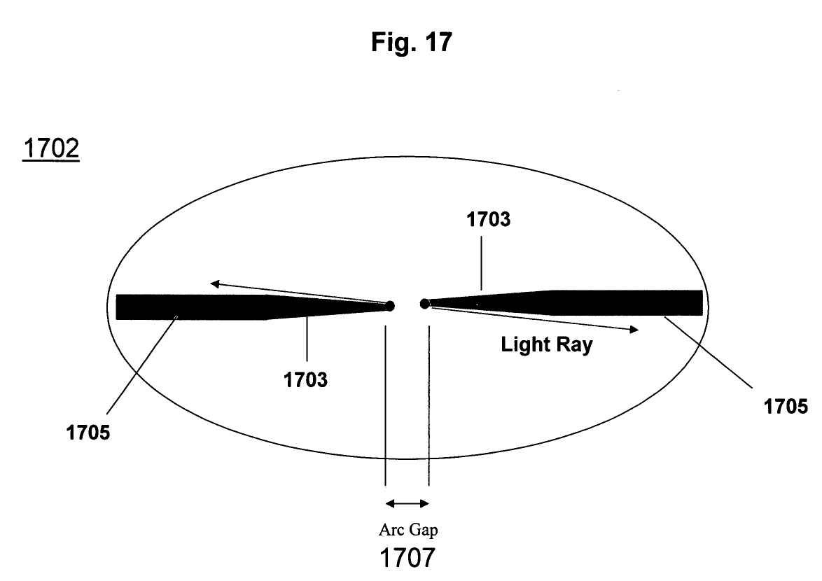

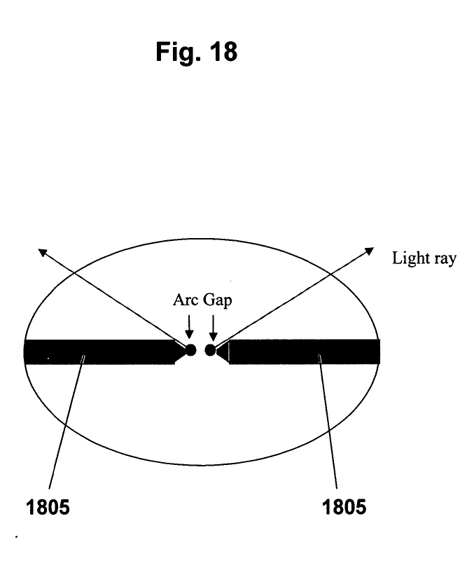

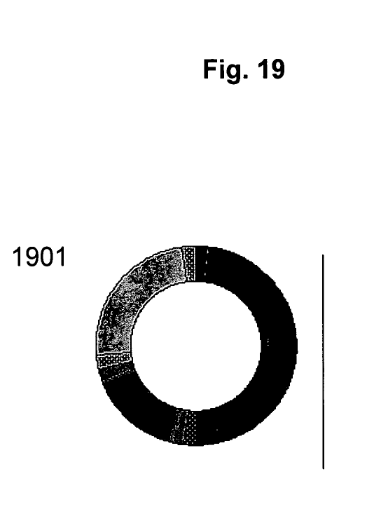

In addition to reducing the arc gap, the geometry of the electrodes may be altered. In general, the short arc gap will result in higher current. To prevent thermal evaporation of the electrode due to high power load, the electrode is made thicker. However, mere thickening would have an adverse effect of shadowing the light passing through the aperture, particularly given a small arc gap. With reference to FIG. 17, the interior end portions 1703 of the opposing electrodes 1705 may be tapered toward the interior tip while keeping the shank relatively thick, thereby exposing more light rays to the reflector. The tapered electrodes 1705, 1805 are illustrated in FIGS. 17 and 18. As shown in FIGS. 17 and 18, the degree of shadowing by the electrodes may be reduced by the degree of taper provided on the electrodes. Flicking can be more of an issue for the short gap arc tube, and it has been found that the tapered electrode also helps stabilize the arc to prevent flicking.

In addition to altering the electrode design, the light source etendue can be further reduced by constricting the arc. Several methods are disclosed for constricting the arc. In one embodiment, a high ionization potential gas such as neon is used to constrict the arc. Neon may also provide useful color in red, especially in view of the particular spectral deficiencies known in UHP sources. The constricted arc improves the etendue lumen efficiency. In another embodiment, a halide such as iodine may be used in the fill material to assist with the constriction of the arc. In a further embodiment, a permanent magnet may be used to create an axial magnetic field for constricting the arc. Known as pinching-the-plasma, high-field magnets such as Nd—Fe—B can be made into a customized shape to produce a field adequate to pinch the plasma. The magnetic field can also help starting because the electrons are confined by the magnetic field, thereby reducing the glow-to-arc transition time or reducing the start voltage.

### (B) SPECTRAL OUTPUT

In addition to the etendue and lumens issues addressed by the embodiments above, various embodiments also address color issues including enhancing color performance and tailoring color output to match aspects of a light filter such as a color wheel.

The disclosed metal halide-based lamps provide more balanced and richer color for projection applications. In one embodiment, the color of a metal halide lamp is shown, referring to the CIE xy chromaticity diagram in FIG. 14, to have a bigger gamut area than UHP lamps and more balanced white color. In an exemplary embodiment, the arc tube produces peak amounts of light at wavelengths corresponding to blue, green and red. In further embodiments, the arc tube produces light at wavelengths utilized by the projection system. In selected embodiments, the fill is predetermined, in part, to generate peaks of light at the wavelengths corresponding to blue, green and red, to match the RGB filters in the color wheel, and thus improve the color wheel efficiency. In further embodiments, the color of a metal halide light source is tailored to match a color wheel made for highest color wheel efficiency. In another embodiment, the fill is predetermined, in part, to generate the most screen lumens in accordance with the RGB color wheel. In yet another embodiment, the fill is predetermined, in part, to generate the most screen lumens in accordance with the RGBW color wheel. In an additional embodiment, the fill gas and pressure is predetermined, in part, to restrict the arc to further reduce the etendue of the light source.

In certain embodiments, the color of the light source is tailored by changing the composition of the lamp fill material. Various combinations of materials such as halides, metal halides and metals and filling gas enable the desired spectrum for color and lumen requirements. In certain embodiments, the arc tube is filled with less than 2 mg of material. In preferred embodiments, the arc tube is filled with less than 1 mg of materials.

A particular advantage in using metal halide lamps is that the spectral output of the lamp may be determined by the composition in the lamp fill material. In one embodiment, the fill material is chosen to provide a light output having a spikes in the wavelengths of interest, e.g., in the red region, green region, and the blue region of the light spectrum. For example, in typical LCD, DMD, LCoS applications, light is filtered to provide red, green and blue light. Accordingly, in disclosed embodiments, the dose is predetermined to enhance the color performance of the projection light system by generating peak quantities of light at wavelengths corresponding to blue (for example, 475 nm), green (for example, 510 nm) and red (for example, 650 nm). By transmitting light at the wavelengths utilized by digital projection systems, the efficiency (color wheel efficiency) of the light system is increased. Along with the other features of the disclosed embodiments, a low power light source is provided that produces sufficient light to meet the requirements of projection systems.

According to one aspect, an arc tube is filled with a dose material including metal halides. The arc tube may also include combinations of metal halides, metals and halides. Suitable metals include, but are not limited to, cesium, scandium, rubidium, sodium, aluminum, and manganese. Suitable compositions of fill material include the combination of sodium and scandium. Halides of indium or thorium, or both, may also be included in the fill. Alternatively, the fill material may include combinations of halides of rare earth metals. The fill material may be introduced into the arc tube by the processes disclosed in U.S. Pat. No. 6,612,892, U.S. Pat. No. 6,517,404 and U.S. patent application Ser. No. 10/457,442. These manufacturing processes enable utilization of a wide variety of metal halide fill material composition. As such, the luminance and color rendering of the metal halide lamp has been better adapted to the needs of projection lighting.

In certain embodiments, the fill pressure in the arc tube at substantially room temperature is generally less than about 5 atm. at room temperature. Optionally, the fill gas pressure is less than about 10 atm. at room temperature, or the fill gas pressure is less than about 2 atm. at room temperature. The typical pressure at operating temperature is between about 25 atm and 35 atm.

In certain embodiments, the chamber of the arc tube is generally an oblate spheroid having diameter of 8 mm or less. In another embodiment, the diameter is 6 mm or less.

In certain embodiments, the light source includes less than 0.5 mole/liter of fill gas, less than 20 μg/μl mercury, and/or less than 4 μg/μl halides. Alternatively, the light source includes less than 0.05 cc of fill gas, 1.5 mg mercury or less, and/or less than 0.5 mg halides.

Choices in fill gas also enhance color performance. Suitable fill gases include krypton, xenon, argon, neon, and combinations thereof. In various embodiments, the fill gas also improves the arc constriction described previously.

In certain embodiments, the light source includes less than 0.5 mole/liter of fill gas, less than 20 μg/μl mercury, and/or less than 4 μg/μl halides. Alternatively, the light source includes less than 0.05 cc of fill gas, 1.5 mg mercury or less, and/or less than 0.5 mg halides.

The spectral output of the lamp may also be tailored using thin film coatings on the arc tube. In one embodiment, an optical interference coating is predetermined in view of the fill to enhance reflectivity of light at particular wavelengths in blue, green and/or red, so as to achieve designed color wheel efficiency and color requirement on the screen. In alternative embodiments, the coating can be of a filtering type to enhance one color. Other coatings such as TiO₂ to block UV produce some color shift effects as well. These effects are produced because the coating material absorbs the UV energy and elevates the wall temperature, thereby triggering a chain reaction. In tests, higher lumens output and red shift of the spectrum have been observed due to the TiO₂ coating. Further, wall temperature was more inform. Similarly UV-blocking quartz may be used to perform a similar function. Generally, these films reduce the load of UV downstream and improve the lumens output of the arc tube.

More generally, coating the arc tube to gain lumens also enables the color to be tailored for the gain of color wheel efficiency and customized color. In alternative embodiments, the arc tube includes optical interference filtering to reflect at least one of ultraviolet (UV) or infrared (IR) radiation.

In one embodiment, the coating is formed by LPCVD. In another embodiment, the coating is formed by e-beam evaporation. In a further embodiment, the coating is formed by reactive sputtering.

### (C) HALIDE POOL

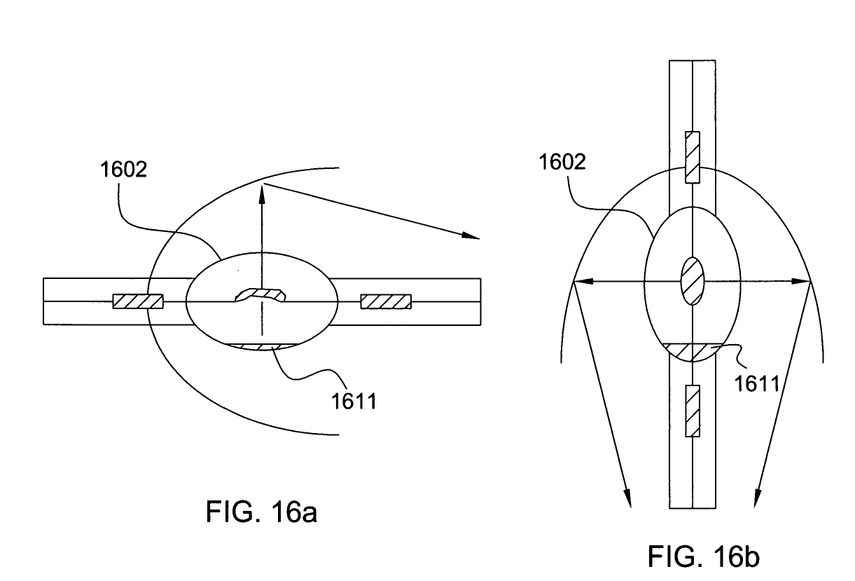

The halide pool relates to both lumen and color issues. The halide pool typically sits at the bottom of a horizontally burned arc tube and blocks or filters some light as illustrated in FIG. 16a. The absorption by the halide pool is generally in the blue region of the spectrum thereby decreasing lumens and color wheel efficiency, so there is a need to reduce its effect. Several approaches are considered below. First, the arc tube geometry and wall thickness is changed to improve the wall temperature uniformity and reduce the halide pool. Second, a UV absorption coating is used to heat the arc tube wall to reduce the halide pool. Third, the amount of the metal halide dose can be optimized to so less is in the liquid phase to accumulate in the halide pool. Fourth, with reference to FIG. 16b, the arc tube 1602 may be operated in a vertical configuration so the halide pool 1611 does not impede the light emitted from the plasma and collected by the reflector.

### (D) TUBE ENVELOPE/GEOMETRY

Various embodiments alter the geometry of the arc tube or the wall thickness. These modifications advantageously improve wall temperature uniformity and reduce the halide pool.

In various embodiments, the arc tube envelope geometry, shape, wall thickness, are made to optimize wall temperature uniformity and handle the internal pressure during operation.

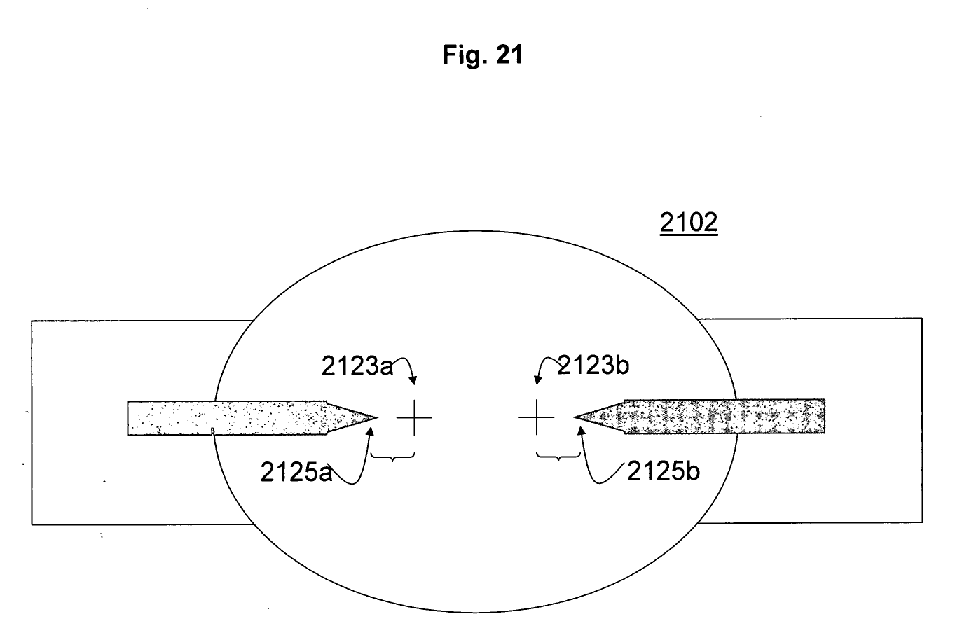

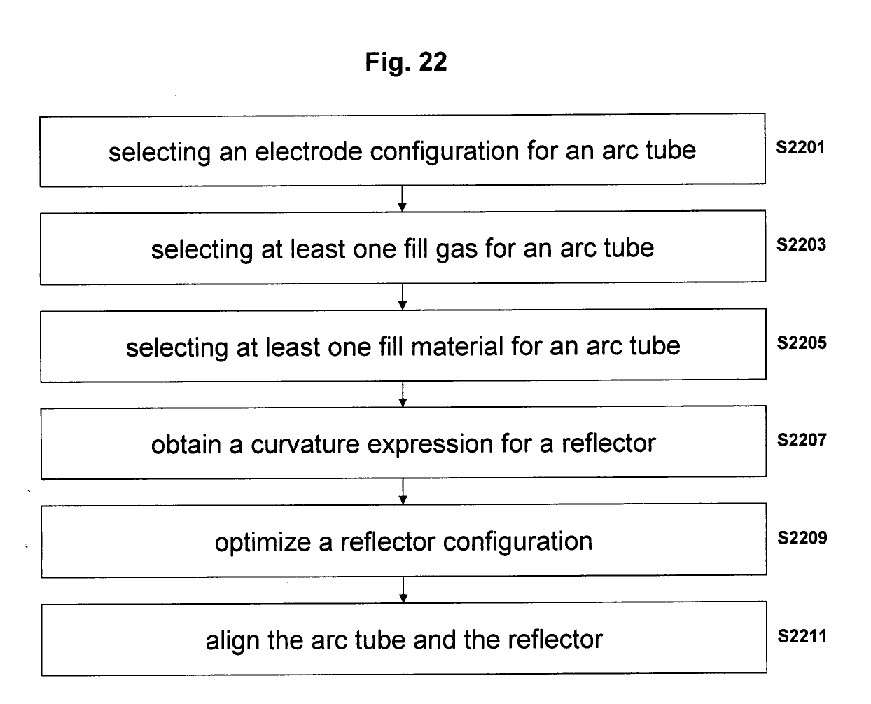

In one embodiment illustrated in FIG. 21, the arc tube 2102 is substantially elliptical and has first and second elliptical focal points 2123a, 2123b respectively intermediate first and second electrode tips 2125a, 2125b.

The thickness and shape of the arc tube is determined by the safety concerns. In one embodiment, the arc tube is double elliptical and has two elliptical focal points respectively intermediate first and second electrode tips.

The arc tube is optionally tipless, enabling heat to be substantially evenly distributed on the arc tube wall. The arc tube substantially follows the shape of the arc, thereby reducing photon scattering from the tip. Additionally, this tipless arc tube does not have a tubulation defect on the surface of the completed discharge lamp thus eliminating light blockage and refraction caused by such defects. Additionally, heat is more evenly distributed on the arc tube wall. Even heat distribution is particularly desirable in the small arc tubes demanded in projection lighting systems.

The disclosed arc tube can be made using a variety of materials. In one embodiment, the arc tube is formed from quartz. In a further embodiment, the arc tube is formed from ceramic. In certain embodiments, the arc tube is made of UV blocking quartz. The UV radiation from the light source is significantly reduced to minimize the aging due to UV. In an alternative embodiment, the arc tube is coated with TiO₂ as UV blocker. The absorbed UV energy contributes to elevated wall temperature and uniformity. In other embodiments, the arc tube may be made of sapphire or other crystals for reducing scattering on the arc tube and for increasing wall temperature.

Optics of the arc tube shape are also considered in the reflector design described in Part III below.

### (E) BALLAST

Some embodiments include a more efficient and intelligent ballast for the projection application. In one embodiment, an asymmetric ballast cancels out the asymmetric operation between the two electrodes due to factors such as thermal convection and misalignment. Alternatively, the asymmetrical ballast can be used to increase the lumens output from the vicinity of one electrode. Since the reflector typically has one focal position, the reflector can be designed optically around the brighter electrode. In other words, the asymmetric operation can effectively reduce the Etendue of the light source.

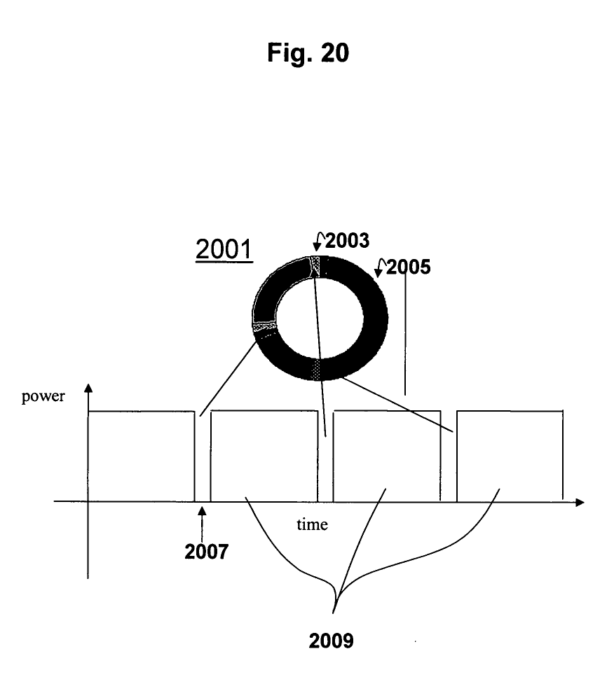

In other embodiments, the duty cycle of the ballast is reduced while maintaining the same lumens output by taking advantage of a spoke area of a color wheel or analogous portion of a similar color filtering device. With reference to FIG. 20, a conventional color wheel 2001 includes a non-light transmitting “spoke” sector 2003 separating each of the red, green and blue filters. Each spoke sector 2003 spans about 8 degrees, so that a color wheel 2001 including three such spoke sectors 2003 includes a dark period of about five percent of the wheel. Selected embodiments cycle the lamp off during the spoke period 2007 and back on during the red, green or blue filtering periods 2009 while maintaining the same average electrode load. Alternatively, the ballast can be used to switch off the lamp during the spoke period to achieve the same screen lumens with less input power. This reduces the overall heat effect.

The factor considered in designing the ballast include the voltage, current, and power requirements of the arc tubes. For instance, in certain embodiments, the ballast voltage and current pulses are sufficient to strike the light source and make the glow-to-arc transition within a predetermined time. Further, the ballast has sufficient voltage and current pulses to hot restrike the light source within the predetermined time.

In one embodiment for a 35 Watt light source, the ballast voltage is approximately 65 Volts and the ballast strikes the light source with 8 kV current pulses. The ballast restrikes the hot light source within 10 seconds.

The factors considered in ballast design also include the size and thermal requirements of the completed system including the light source. In one embodiment, the ballast has a total weight or mass of less than 46 g. In another embodiment, the ballast has the overall dimensions of 72 mm×15 mm×50 mm or a corresponding volume of less than 54,000 mmˆ3. In certain embodiments, the ballast produces 0.76 Watts/gram.

Embodiments of the ballast operate in AC or DC mode. In AC embodiments, the waveform is sinusoidal or square. In one embodiment, a square wave switching ballast powers a 35 W light source with frequency of 7 KHz. Alternatively, a semi-DC ballast enables asymmetric operation between the electrodes. As described previously, this asymmetric ballast may alleviate asymmetric thermal and electrode misalignment issues.

In other embodiments, the waveform of the ballast is modulated to change the power and color balance of the light source. Accordingly, the source can be optimized for the color and brightness of a particular color generated by a light engine (for example, a color within a blue, green, or red segment of a color wheel).

In other embodiments related to systems employing a color wheel or similar alternating or periodic color device, the ballast shuts down the light source during the spoke segment of the color wheel so the light source is used more efficiently, thereby increasing the screen lumens per watt performance. In selected embodiments, the ballast contains a microchip to shut down the light source after a designed period of time.

In another aspect, the light source optionally includes a timed-life feature to disable the light source based on a predetermined value of one or more parameters including, but not limited to, light output, hours of operation, lamp current, lamp voltage. For example, the ballast may be programmed to cut off lamp current to disable the lamp based on the hours of operation of the lamp or the measured light output from the lamp.

### [II.] REFLECTOR

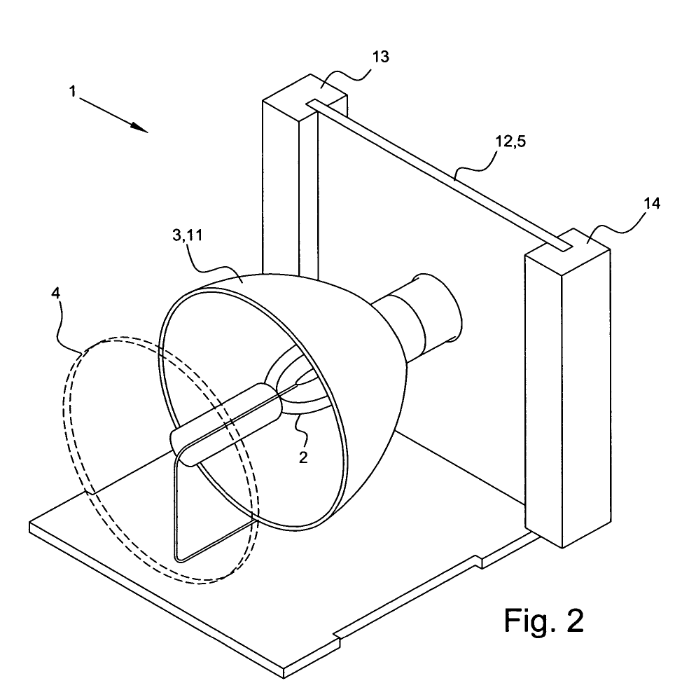

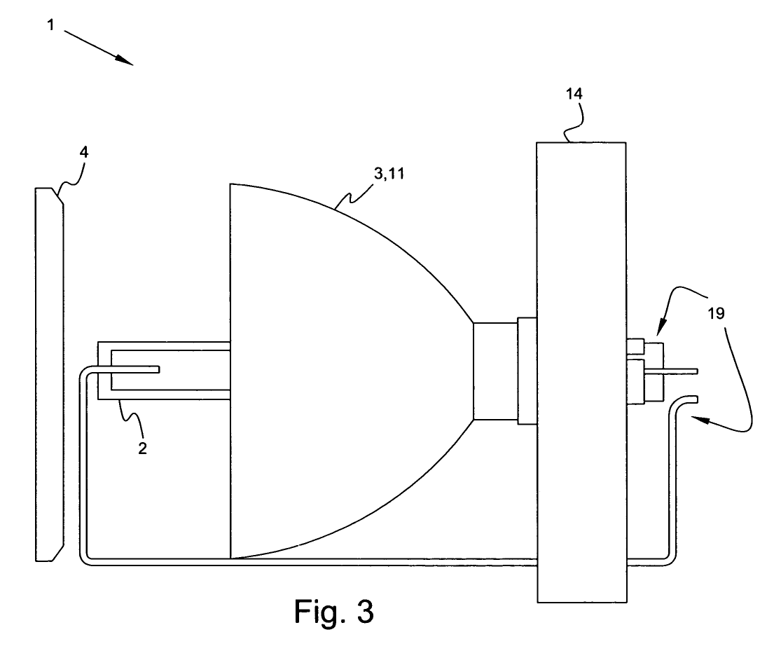

Exemplary embodiments of an arc tube 2 and reflector 3 are positioned as depicted in FIGS. 2 and 3. In one embodiment, the reflector 3 is formed from quartz by the spin mold process described in U.S. Pat. No. 6,546,752. A reflective coating 9 is deposited on the interior surface via a LPCVD, or another suitable coating process to provide a highly uniform reflectance profile. The reflector 3 and the arc tube 2 form the reflector lamp subassembly 11. In a 35 W embodiment, the reflector has a maximum diameter of about 30 mm.

In a preferred embodiment, an elliptical reflector is used to focus the light. In one embodiment, the lamp is located roughly at one focus of the ellipsoid and the aperture sits at the other focus. However, since the arc is not a point, the reflector design requires an analysis of arc performance.

### (A) REFLECTOR CURVE DESIGN

Accordingly, specific knowledge is required regarding the light distribution of the arc. This light distribution information can be obtained by taking images of the arc from different angles and analyzing them digitally to create a digital 3-D profile of the arc.

In various embodiments, the design of reflector curvature generally includes two steps. First, an analytical expression is obtained for the curvature for focusing the light into the aperture. This step optionally includes assuming the arc as a point source to simplify or accelerate the analysis. Second, optical simulations are used with the arc profile data from the first step to fine tune the curvature and achieve optimal performance.

### (B) REFLECTOR BODY

Generally, the reflector 203 collects light from the arc tube 202 and projects it down the light path. FIG. 14 illustrates this concept. As used herein, aperture generally describes the physical size of optical elements including, but not limited to, the lens, the integrating rod, and the micro display unit. The smallest optical element generally determines the system aperture. In the case of DMD and other projection lighting systems, aperture is generally small. The small size of the aperture is generally driven more by economic reasons than technical ones. Accordingly, certain embodiments described herein use an aperture size of 4-6 mm. The aperture can also be of various shapes, including, but not limited to, elliptical (circular) and rectangular (including square).

In one embodiment, the reflector opening diameter is 45 mm or less. In another embodiment, the diameter is 30 mm or less. In yet another embodiment, the diameter is 25 mm or less. In further embodiments, the diameter of the reflector opening corresponds to a power rating or a thermal rating of the projector.

In one embodiment, the reflector total length is less than about 40 mm. In a preferred embodiment, the reflector total length is less than about 25 mm. In one embodiment, the length, as defined by a semiminor axis of an ellipse, is less than about 20 mm. In another embodiment, the length, as defined by a semiminor axis of an ellipse, is less than about 15 mm.

The reflector according to various embodiments may include a wide range of materials. Suitable reflector materials include metals and other materials including, but not limited to, ceramics, glass, polymers, and crystals. In one embodiment, the reflector is substantially quartz. In another embodiment, the reflective surface is metal. In yet another embodiment, the reflector is ceramic. In an additional embodiment, the reflector includes glass. In yet an additional embodiment, the reflector includes a polymer.

Although the reflector may be a separate or distinct structure from the housing, in certain embodiments, the reflector is integrated into the housing of the projection lighting source. This integration is preferably achieved by carving the reflector curvature into the housing. In one embodiment, the housing and the reflector are integrally formed as one body 1501. The reflection surface 1503 is carved by machining, etching, or casting the body, and then finished with polishing and coating.

In one embodiment, the reflector is integrated into the housing to provide an efficient heat sink for the light source. The integrated housing optionally incorporates heat sink features such as vanes, flanges, ducts, or mesh to increase surface area to dissipate heat. In certain embodiments, the reflector surface is carved into the housing body. The carved surface is manufactured using a variety of methods, including, but not limited to, machining or casting. Further, the carved surface may be polished, etched and coated. Alternatively, the reflector is made by a process of spin molding, metal machining, or metal stamping.

In one embodiment, the reflector front is open. In a second embodiment, the reflector front has a front cover. The reflector front cover may include an optical interference filter.

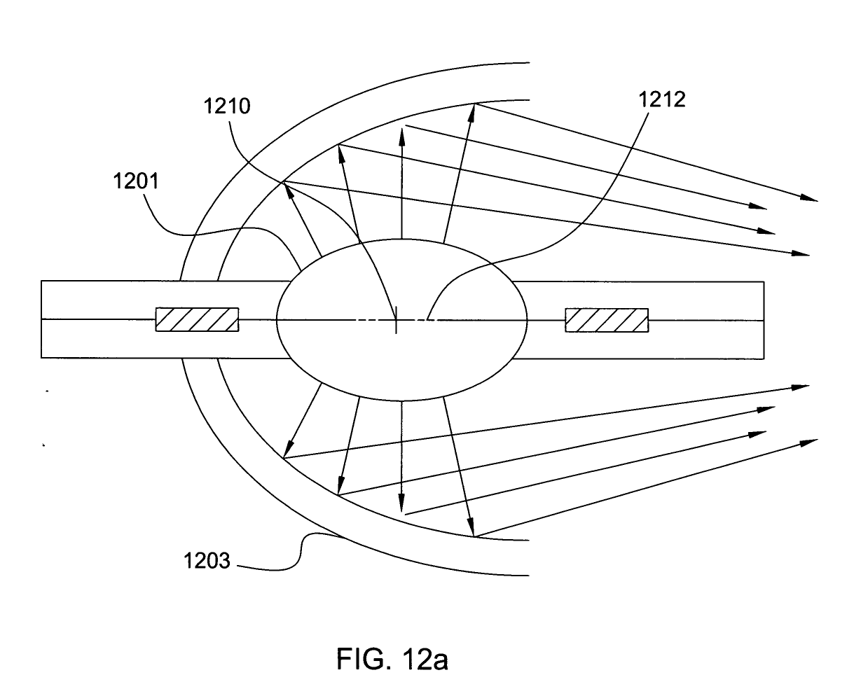

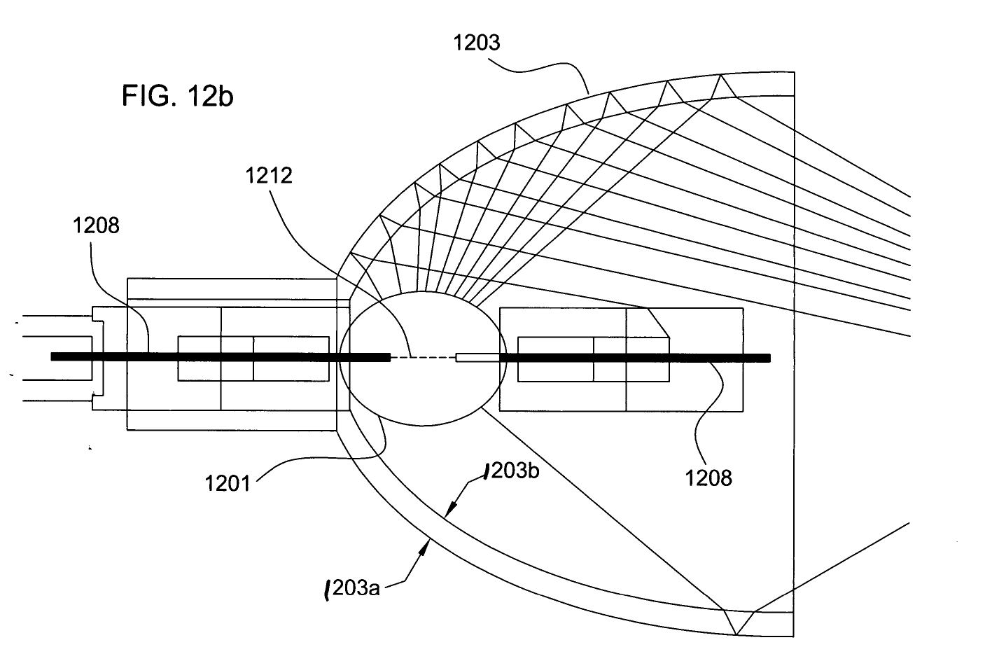

FIG. 12a illustrates one embodiment of the positioning of the reflector 1203 with the lamp 1201. The reflector 1203 may be substantially ellipsoidal having a focus 1210 positioned on the axis 1212 extending between the interior tips of the electrodes 1208.

### (C) REFLECTOR COATING

With reference to FIG. 12b, in certain embodiments, the reflector 1203 optionally includes a reflective coating on either or both the inner and outer surface of the reflector 1203. In various embodiments, a reflective coating (not shown) is formed on the inner surface 1203b of the reflector 1203 using formation methods including, but not limited to, LPCVD, electron beam evaporation, and plasma assisted sputtering. In additional embodiments, a reflective coating (not shown) is formed on the outer surface 1203a of the reflector using formation methods including, but not limited to, LPCVD and evaporation coating

### (D) REFLECTOR EXAMPLE 1

### Quartz Reflector

In exemplary embodiments, the reflector is a quartz reflector. The quartz reflector according to this embodiment is made by a process of spin molding. Generally, spin molding produces a more uniform reflector shape than the shape produced using alternative processes (for example, pressing the quartz). The reflector can also be made of quartz using known arc tube forming techniques. Advantages of using quartz include, but are not limited to, high temperature endurance, high surface smoothness, electrical inertness, ease in forming.

After the quartz reflector is formed, a coating is optionally applied. The coating can be accomplished by at least two methods: coating the inside or coating the outside of the reflector. In the first approach, the inside of the quartz reflector is coated by, for example, LPCVD. In the second approach, the outside of the quartz reflector is coated. Coating the outside is effective because the quartz is transparent to the visible light. Further, coating the outside surface offers advantages including enhanced control of the surface curvature, especially where the quartz reflector is formed by molding from the outside. Further, the outside coating approach also allows coating using a sputtering process.

### (E) REFLECTOR EXAMPLE 2

### Metal Block Reflector

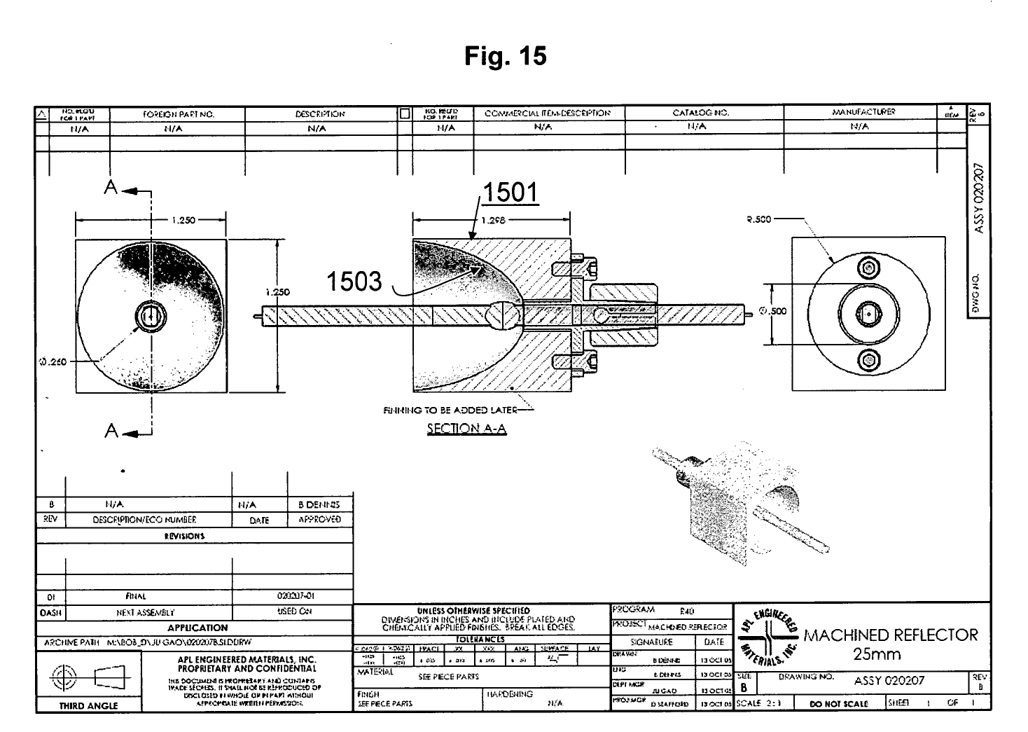

As illustrated in FIG. 15, selected embodiments of the reflector are made directly from a metal block.

The inside curve defining the reflector can be machined to high precision according to the design. Alternatively, the carved surface is cast. The surface is then finished by polishing or etching to improve the optical property. Suitable materials include aluminum and other highly reflective materials. Other suitable materials are optionally coated to achieve the desired high reflectivity. Suitable coating materials include, but are not limited to, a thin aluminum coating (for example, around 100 nm) or a multilayer interference coating.

In one embodiment, the metal reflector also serves as a housing that is positioned and aligned to the whole system. The reflector becomes an alignment and positioning tool for the light engine. The high thermal conductivity of the metal reflector makes it a good heat sink as well. The reflector conducts the heat from the arc tube directly to the system housing. Thus, in certain embodiments, the reflector serves as the housing and heat sink of the light engine assembly, and includes a carved the surface to perform the optical function.

### [III.] HOUSING

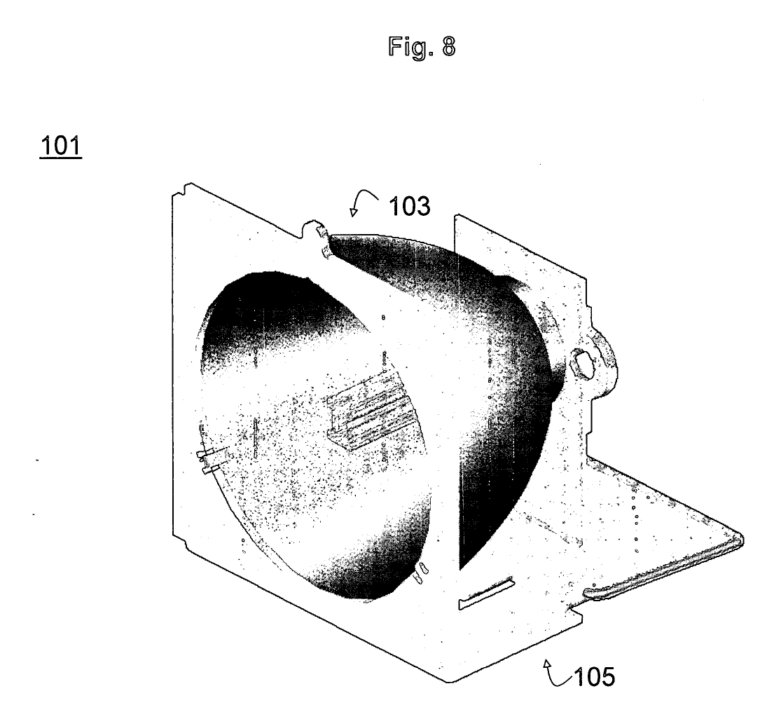

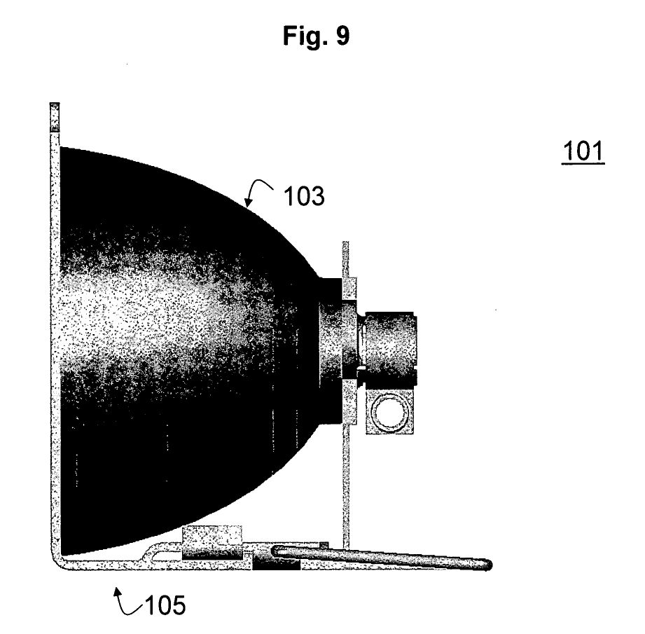

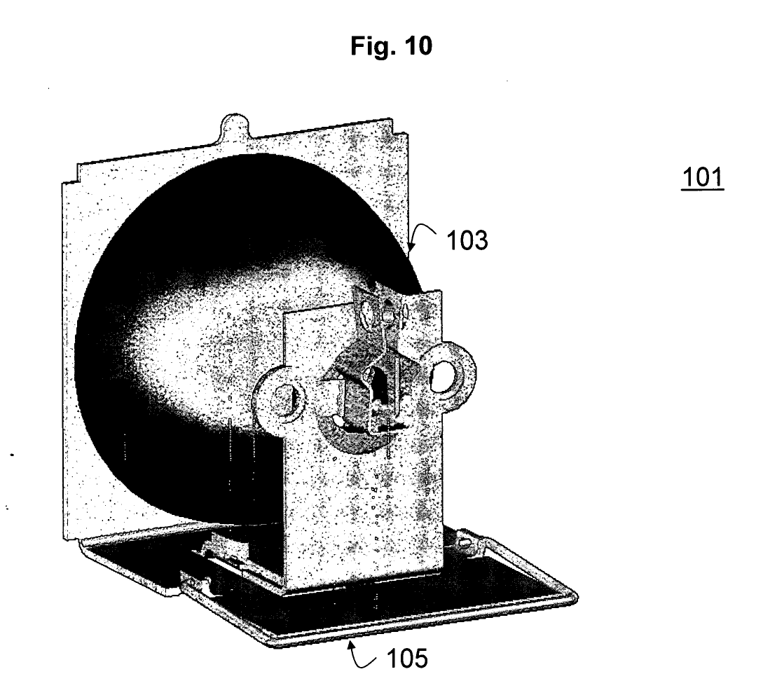

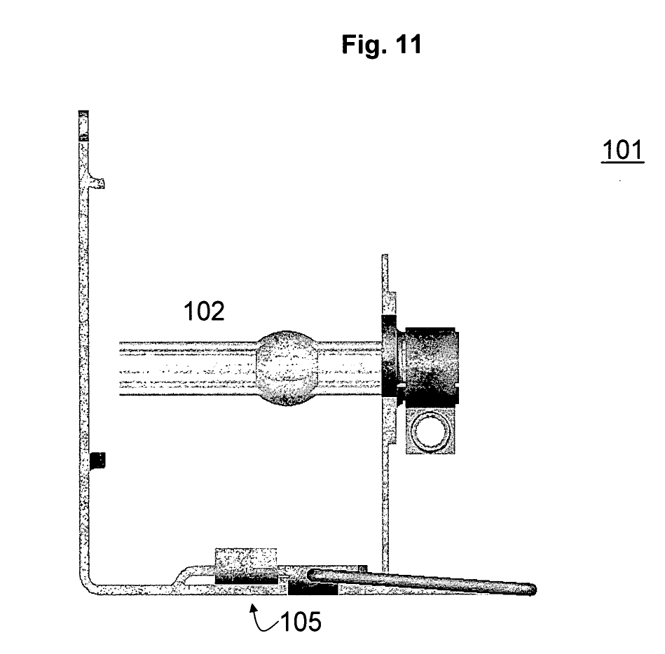

As depicted in FIGS. 1 to 4 (and FIGS. 8-11), exemplary embodiments of the reflector lamp subassembly 11 are mounted to the housing 5. The light source housing 5 (105) includes a mechanical assembly to align and hold an arc tube 2 (102) within a reflector 3 (103) to provide precise mechanical interface with the projector optics. The light source housing optionally includes a cover 6, a back plate 12, first and second vertical slides 13, 14, and a lens 4. The lens 4 is disposed forward of the reflector light subassembly 11 to allow transmittance of light therefrom. In one embodiment, the lens 4 focuses light emanating from the reflector lamp subassembly 11. In certain embodiments, the lens includes an optical interference filter. In one embodiment, a front lens 4 is utilized which includes an optical interference filter to block at least one of UV and IR radiation from entering the optical relay and impinging on the DMD chip. The first and second leads 19 from the arc tube 2 protrude from the back plate 12 for electrical connection with the projection lighting system. In combination, the cover 6 and the back plate 12 optionally form the walls of the housing 5 and encase the reflector lamp subassembly 11. The back plate 12 and the cover 6 are joined by the first and second vertical slides 13 and 14. The components of the housing 5 are optionally joined mechanically without cement or other adhesive. Alternatively, heat-resistant adhesive is used.

The housing 5 (105) is preferably formed with standardized dimensions, weight, and electrical connections. Furthermore, the housing 5 (105) is preferably formed with standardized light transmittance dimensions for efficient coupling of light emitted from lens 4 to the light projection system. By efficiently coupling the light source I to the digital projection systems such as those shown in FIGS. 5-6 and 13, sufficient light is coupled with a reduced demand on lamp power rating.

Embodiments of the housing include housings configured to accommodate vertical or horizontal operational modes of the light source. Further, embodiments of the housing 5 (105) utilize various materials. For example, the housing 5 (105) may be machined out of metal, cast metal, made out of stamped metal structures, or made from ceramic or glass or plastic.

In the embodiment illustrated in FIG. 15, the housing holds the light source and reflector in one piece wherein the light source position and alignment in reference to the reflector may be adjusted.

In various embodiments, the housing design is in accordance with the thermal environment of a projector and light engine components. In selected embodiments, the housing 5 provides a venting air path for the light source. Alternatively, the housing 5 provides a heat pipe or heat conduction conduit to improve the interior thermal environment. Further, embodiments of the housing accommodate various safety considerations such as the wiring of the electrical leads.

### [IV.] SYSTEM VARIANTS

In another embodiment, the light engine assembly, the arc tube and reflector, burn vertically as opposed to horizontally. The vertical burning light engine improves lumens and color wheel efficiency by removing the halide pool from the critical optical path. FIG. 16 illustrates a vertically oriented arc tube.

Further, heat dissipation is enhanced in the vertical configuration. Thus, the system will have more surface area to radiate heat because of the smaller contact area at the bottom.

An UV/IR filter is optionally deposited on the arc tube wall. Alternatively, the filter is spaced apart from the arc tube.

### [V.] PERFORMANCE

Disclosed embodiments advantageously provide demonstrable performance benefits over prior art devices. Performance benefits include, but are not limited to, advantages in power, light output, effective light output, starting, and physical specifications.

As described above, presently disclosed embodiments exhibit far superior power ratings performance over prior art devices. In certain embodiments, the lamp operates at 100 Watts or lower. In preferred embodiments, the lamp operates at 50 Watts or lower. In other preferred embodiments, the rated power is between 20 Watts and 40 Watts. In more preferred embodiments, the lamp operates at 35 Watts or lower. In even more preferred embodiments, the lamp operates at 10 Watts or lower.

Disclosed embodiments also provide enhanced light output (for example, in lumens) and effective light output (for example, in screen lumens). For example, various embodiments of the arc tube, fill material, and optical interference filter produce light with a Color Correlated Temperature (CCT), Chromaticity (ccx, ccy), and lumens/watt sufficient for light projection.

In one embodiment, the power rating is about 35 W with over 75 Lumens/Watt, and the CCT is in the range of 4K to 8K.

In certain embodiments, the light source has a color wheel efficiency greater than 20 percent. In preferred embodiments, the color wheel efficiency is greater than 25 percent. In more preferred embodiments, the color wheel efficiency is greater than 30 percent.

In certain embodiments, the light source produces at least about 600 lumens. In a preferred embodiment, the light source produces between about 600 and 5000 lumens. In a more preferred embodiment, the light source produces between about 1000 and 4000 lumens.

The light source produces between about 200 and 3000 lumens at 4 mm circular aperture with less than 30 degree half cone angle.

Certain embodiments of the light source provide at least 2 lumens per watt of RGB light. In a preferred embodiment, the light source provides at least 3 lumens per watt of RGB light.

Preferred embodiments produce effective light output for projection systems in the range of 50 to 500 screen lumens. Selected embodiments of the light source produce between about 20 and 300 screen lumens.

In certain embodiments, the light source operates at less than 50 Watts and directs at least 800 lumens of light at an etendue of no more than 2.76 mm².sr. In a preferred embodiment, the light source directs at least 1200 aperture lumens of light. In a more preferred embodiment, the light source directs at least 2000 aperture lumens of light.

In disclosed embodiments, the light source rated power is less than about 100 W and produces greater than about 20 screen lumens. In another embodiment, a projection light source includes a light source with a rated power of less than about 50 W that produces greater than about 50 to 200 screen lumens.

The light source efficacy may be greater than about 65 integrated lumens/watt, and may be greater than about 85 integrated lumens/watt.

Selected embodiments of the light source provide at least 3 screen lumens per watt. For example, a 35 watt source embodiment provides 105 screen lumens. The light source optionally provides greater than 4 screen lumens per watt. The light source optionally provides greater than 5 screen lumens per watt.

In certain embodiments, the light source has a lamp life greater than about 500 hours rated for 75% lumen maintenance. In preferred embodiments, the light source has a lamp life greater than about 1000 hours rated for 50% lumen maintenance.

Disclosed embodiments also provide enhanced starting and re-strike performance. In certain embodiments, the light source requires a starting voltage of less than 8 kV. In preferred embodiments, the light source requires a starting voltage from 2 kV to 8 kV. In certain embodiments, the light source uses a starting pulse width between 100 ns to 300 ns. In preferred embodiments, the light source uses a starting pulse width of about 200 ns.

With regard to warm-up periods, certain embodiments of the lamps reach 80% brightness (for example, of full lumens performance) in less than 10 seconds. Preferred embodiments reach 80% brightness in less than about 5 seconds.

With regard to re-strike times, certain embodiments of light sources achieve an instant or quick re-strike in less than 1 second. Various embodiments of light sources achieve a quick re-strike in less than 30 seconds. In preferred embodiments, quick or hot re-strike is achieved in less than 10 seconds.

In addition to providing enhanced performance, disclosed embodiments also provide high performance in a more compact and lower mass device. In certain embodiments, the light source is less than about 200 g, including the housing, reflector and lamp. In preferred embodiments, the light source is less than about 100 g, including the housing, reflector and lamp. In certain embodiments, the light source assembly fits into a volume of 38 mm by 36 mm by 36 mm or less. Further, in various embodiments, the light source has a weight-to-volume ratio of less than about 2.5 g/cc.

In certain embodiments, the light source produces greater than about 250000 screen lumens/g weight of fill material. In a preferred embodiment, the light source produces about 315000 screen lumens/g weight of the fill material. In a more preferred embodiment, the light source produces greater than about 333000 screen lumens/gram weight of fill material. In certain embodiments, the light source produces greater than about 5 million integrated lumens/g weight of fill material. In a preferred embodiment, the light source produces greater than about 9 million lumens/g weight of the fill material.

In certain embodiments, the light source produces greater than about 200 integrated lumens/cc volume of the light source. Further, certain embodiments of the light source produce greater than about 80 integrated lumens/g weight of the light source. In various embodiments, the light source produces greater than about 7 screen lumens/cc volume of the light source. Further, in various embodiments, the light source produces greater than about 2.8 screen lumens/g weight of the light source.

Various embodiments of the disclosure also provide advantages over prior art devices with regards to safety. As described previously, the failure mode of UHP devices tends to be catastrophic explosion releasing more than 2.5 Joules of energy contained in the light source. In contrast, an arc tube according to various disclosed embodiments contain less than 0.5 Joules of energy. In a preferred embodiment, the arc tube contains approximately 0.15 Joules of energy. In a more preferred embodiment, the arc tube contains approximately 0.11 Joules of energy.

In certain embodiments, the light source may be made to meet a predetermined maximum power limitation to allow for battery operation. Additionally, selected embodiments of the light source produce less than the maximum IR requirement of the projector. Further, various embodiments of the light source have less than 15% of the total radiation energy in ultraviolet radiation and less than 20% in infrared radiation.

Process descriptions or blocks in flow charts should be understood as representing modules, segments, or portions of computer software or code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

The embodiments disclosed herein for methods of designing an arc tube, a reflector, a housing, or a projection light source can be implemented using computer usable medium having a computer readable code executed by special purpose or general purpose computers.

It should be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. While preferred embodiments have been described, it is to be understood that the embodiments described are illustrative only and the scope of the disclosure is to be defined solely by the appended claims when accorded a full range of equivalence, many variations and modifications naturally occurring to those of skill in the art from a perusal hereof.

What is claimed is:

1. A projection light source comprising:
a housing;
an arc tube supported by said housing, said arc tube comprising:
an arc tube body having a bulbous chamber intermediate sealed end portions;
a pair of electrodes, each electrode extending from a sealed end portion into said chamber so that the distance between the interior tips of said electrodes is between about 1.0 mm and about 2.5 mm, each of said electrodes comprising a tungsten shank having a diameter between about 2.0 mm and about 4.0 mm;
a fill gas contained within said chamber, said fill gas comprising one or more gases selected from the group consisting of argon, xenon, krypton and neon, said fill gas having a pressure less than about 5 atm at substantially room temperature;
a fill material contained within said chamber, said fill material comprising one or more halides of one or more metals; and
mercury contained within said chamber; and
a generally ellipsoidal reflector supported by said housing, said arc tube and said reflector being positioned so that a focus of said generally ellipsoidal reflector lies on an axis extending between the interior tips of the electrodes of said arc tube.

2. The projection light source of claim 1 operating at no greater than 50 watts and projecting at least 800 lumens at an etendue of no greater than 2.76 mm²sr.

3. The projection light source of claim 2 operating at no greater than 50 watts and projecting at least 1200 lumens at an etendue of no greater than 2.76 mm²sr.

4. The projection light source of claim 1 wherein said arc tube is formed from quartz or ceramic material.

5. The projection light source of claim 4 wherein said reflector is formed from quartz, ceramic, polymer, glass, or metal.

6. The projection light source of claim 5 wherein said arc tube body is formed from quartz and said reflector is formed from glass.

7. The projection light source of claim 1 wherein said fill gas comprises neon and said fill material comprises sodium, scandium and indium.

8. The projection light source of claim 1 wherein said fill material comprises sodium and scandium.

9. The projection light source of claim 8 wherein said fill material comprises indium.

10. The projection light source of claim 9 wherein said fill material comprises thorium.

11. The projection light source of claim 1 wherein the semiminor axis of said generally ellipsoidal reflector is less than about 25 millimeters.

12. The projection light source of claim 11 wherein the semiminor axis of said generally ellipsoidal reflector is less than about 20 millimeters.

13. The projection light source of claim 12 wherein the semiminor axis of said generally ellipsoidal reflector is less than about 15 millimeters.

14. An arc tube comprising:
an arc tube body having a bulbous chamber intermediate sealed end portions;
a pair of electrodes, each electrode extending from a sealed end portion into said chamber so that the distance between the interior tips of said electrodes is between about 1.0 mm and about 2.5 mm, each of said electrodes comprising a tungsten shank having a diameter between about 2.0 mm and about 4.0 mm;
a fill gas contained within said chamber, said fill gas comprising one or more gases selected from the group consisting of argon, xenon, krypton and neon, said fill gas having a pressure less than about 5 atm at substantially room temperature;
a fill material contained within said chamber, said fill material comprising one or more halides of one or more metals; and
mercury contained within said chamber.

15. The arc tube of claim 14 wherein said chamber contains less than about 0.5 moles of fill gas per liter of chamber volume, less than about 4 micro grams of halides per micro liter of chamber volume, and less than about 20 micro grams of mercury per micro liter chamber volume.

16. The arc tube of claim 14 wherein the shanks of said electrodes each include a tapered portion terminating at the interior tip of said electrode.

17. The arc tube of claim 14 wherein the axial distance between the interior tips of said electrodes is between about 1.6 mm and about 1.9 mm.

18. The arc tube of claim 14 wherein the axial distance between the interior tips of said electrodes is about 1.7 mm.

19. The arc tube of claim 14 wherein said fill material comprises halides of sodium and scandium.

20. The arc tube of claim 19 wherein said fill material further comprises indium.

21. The arc tube of claim 14 wherein said chamber is generally spherical having a diameter of less than 8 millimeters.

22. The arc tube of claim 21 wherein said diameter is about 6 millimeters.

23. A low wattage light source for a projection lighting system comprising an arc tube containing a light emitting plasma including one or more metal halides and a reflector for directing light emitted from said plasma, said light source operating at no more than 50 watts and directing at least 800 lumens of light at an etendue of no more than 2.76 mm²sr.

24. The light source of claim 23 operating at about 45 watts.

25. The light source of claim 24 operating at about 35 watts.

26. The light source of claim 23 directing at least 1200 lumens of light at an etendue of no more than 2.76 mm²sr.

27. The light source of claim 26 directing at least 2000 lumens of light at an etendue of no more than 2.76 mm²sr.

28. A low wattage light source for a projection lighting system comprising an arc tube containing a light emitting plasma including one or more metal halides and a reflector for directing light emitted from said plasma, said light source being capable of directing at least 800 lumens of light at an etendue of no more than 2.76 mm²sr. while operating at no more than 50 watts.

29. A lamp for a projection lighting system comprising a chamber containing a plasma including one or more metal halides, the composition of said metal halides being selected so that the color separation efficiency of the light emitted from said plasma when separated by red green and blue filters in a color wheel is greater than 25%.

30. The lamp of claim 29 wherein the color separation efficiency is greater than 28%.

31. The lamp of claim 30 wherein the color separation efficiency is greater than 30%.

32. In a projection lighting system comprising a light source including an HID lamp coupled to a reflector for directing light emitted from said lamp to a color wheel for sequentially filtering said light with red, green, and blue filters, and optics for directing the filtered light to a viewing screen, the improvement wherein the lumens of red, green, and blue filtered light is greater than about 5 per watt of operating power of said lamp.

33. In a projection lighting system comprising a light source including an HID lamp coupled to a reflector for directing light emitted from said lamp to a color wheel for sequentially filtering said light with red, green, and blue filters, and optics for directing the filtered light to a viewing screen, the improvement wherein the ratio of lumens of red, green, and blue filtered light to the lumens of light directed to said filters is greater than about 0.25.

34. The projection lighting system of claim 33 wherein the ratio of lumens of filtered light to the lumens of light directed to said filter is greater than about 0.28.

35. The projection lighting system of claim 34 wherein the ratio of lumens of filtered light to the lumens of light directed to said filter is greater than about 0.30.

36. The projection lighting system of claim 33 wherein said color wheel comprises equal portions of red, green and blue filters.

37. In a projection lighting system comprising a light source including an HID lamp coupled to a reflector for directing light emitted from said lamp to a color wheel for sequentially filtering said light with red, green, and blue filters, and optics for directing the filtered light to a viewing screen, the improvement wherein the lumens of red, green and blue filtered light directed to the viewing screen is greater than about 2 per watt of operating power of said lamp.

38. The projection lighting system of claim 37 wherein said HID lamp includes a lamp fill containing sodium, scandium and indium.

39. A projector providing an image of at least 100 screen lumens, said projector having a light source comprising a metal halide lamp operating at a power of 50 watts or less.

40. The projector of claim 39 wherein said lamp comprises a bulbous chamber containing a fill gas, one or more metal halides, and mercury, wherein the contained atmospheric energy in the chamber is less than about 1.5 Joules.

41. The projector of claim 39 providing an image of at least 200 screen lumens.

42. The projector of claim 39 providing an image between 100 and 500 screen lumens.

43. The projector of claim 39 wherein said metal halide lamp is the only lamp in said light source.

44. A metal halide lamp having an arc gap of less than 2 millimeters operating at a power of 50 watts or less and providing at least 3500 integrated lumens of light.

45. The metal halide lamp of claim 44 having less than about 0.15 Joules of contained atmospheric energy.

46. A low wattage light source for a projection lighting system comprising (a) an arc tube containing a light emitting plasma including mercury and one or more metal halides, and (b) a reflector for directing light emitted from said plasma, said light source operating at no more than 50 watts and directing at least 650 lumens of light at an etendue of no more than 2.76 mm²sr per gram of mercury contained in said arc tube.

47. A projector providing an image of at least 100 screen lumens, said projector including a light source comprising a metal halide lamp operatively coupled to a ballast, said ballast providing a run up current to said lamp between 1.0 and 2.5 amps, a starting voltage greater than 5000 volts, and an operating voltage at greater than 1000 hertz.

48. A low power light source for a projection lighting system comprising an arc tube having an electrode gap of less than 2 mm and a fill material including mercury and one or more metal halides contained in said arc tube, said light source being capable of producing greater than about 2,250,000 integrated lumens per gram of fill material contained in said arc tube.

49. The light source of claim 48 being capable of producing greater than about 11,000,000 lumens per gram of fill material contained in said arc tube.

50. The light source of claim 48 being capable of producing greater than about 200 integrated lumens per cubic centimeter of arc tube volume.

51. The light source of claim 48 being capable of producing greater than about 80 integrated lumens per gram of the arc tube.

52. The light source of claim 48 comprising a reflector coupled to said arc tube for directing light emitted from said arc tube, said light source being capable of directing at least about 900 lumens of light at an etendue of no more than 2.76 mm²sr.
